(19) United States
(12) Patent Application Publication
(10) Pub. No.: US 2004/0196369 A1
(43) Pub. Date: Oct. 7, 2004

(54) Monitoring system

(75) Inventors: Toshihiko Fukasawa, Tokyo (JP); Takashi Oya, Kanagawa (JP)

Correspondence Address: Canon U.S.A. Inc., Intellectual PropertyDepartment, 15975 Alton Parkway, Irvine, CA, 92618-3731, US

(73) Assignee: Canon Kabushiki Kaisha, Tokyo (JP)

(21) Appl. No.: 10/792,947

(22) Filed: Mar. 3, 2004

(30) Foreign Application Priority Data
Mar. 7, 2003 (JP) 2003-062158(PAT.)

(51) Int. Cl. H04N 7/18

(52) U.S. Cl. 348/155; 348/143

(57) ABSTRACT

In a terminal device of a monitoring system, a display unit displays a frame indicating an area to be monitored for an occurrence of motion in a panoramic image window and also displays an identifier identifying the frame. Furthermore, the display unit displays, in a time zone window, the identifier identifying the frame and a field in which a band is displayed to indicate a period of time during which to monitor an occurrence of motion in the area indicated by the frame. If it is detected that a location on the time zone window is specified, the display unit displays a time zone corresponding to the detected location and also displays an area corresponding to the detected location as a motion detection area.

### CROSS-REFERENCES TO RELATED APPLICATIONS

This application claims the benefit of Japanese Application 2003-062158, filed Mar. 7, 2003.

### STATEMENT REGARDING FEDERALLY SPONSORED RESEARCH OR DEVELOPMENT

Not Applicable.

### BACKGROUND OF THE INVENTION

1. Field of the Invention

The present invention relates to a user interface for a monitoring system having a motion detection capability.

2. Description of the Related Art

A monitoring system is known in which an image is taken by a video camera connected with a monitoring device and transmitted to a terminal device at a remote location via a network.

Some monitoring systems for monitoring a remote place via a network have a motion detection capability. The motion detection capability is realized, for example, by performing image processing on an image taken by a video camera thereby detecting a change/motion of the image, and the detection result is supplied to a user (or a terminal device) via a computer network.

In most conventional monitoring systems, motion detection is accomplished using a fixed camera, although many recent monitoring systems use a camera having panning, tilting, and zooming capabilities. The panning, tilting, and zooming capabilities allow a great expansion of a range within which motion is monitored, compared with the range achieved by fixed cameras. However, it is not easy for a user to capitalize on these expanded capabilities in order to effectively monitor a remote location. For example, it may be desirable to monitor an entrance door during daytime, and an emergency exit during nighttime. This can, of course, be accomplished through the use of multiple cameras. However, it is impossible or at the very least difficult for a user to perform such monitoring with a single camera. Therefore, a need exists for a system and method of providing a relatively easy (i.e., user friendly) method of using a single camera to remotely monitor different locations based on the user's preferred settings.

### BRIEF SUMMARY OF THE INVENTION

In view of the above, it is a feature of the present invention to provide a monitoring device capable of setting a spatial range to be monitored and a period of time during which to perform monitoring. Another feature is the capability of providing monitoring history in the form of a list.

In an aspect, to achieve at least one of the capabilities described above, the present invention provides a terminal device for monitoring an image output from an imaging device. The terminal device includes a display unit for displaying, on a screen, a panoramic image window and a time zone window in which a band is displayed to indicate a time zone during which to monitor an occurrence of motion in the image taken by the imaging device. The terminal device includes a detection unit for detecting which location on the screen is specified. The terminal device also includes a setting unit for performing setting associated with a motion detection process in accordance with a display status of the time zone window. If the detection unit detects that a location on the panoramic image window is specified, the display unit displays a frame indicating an area to be monitored for motion in an area including the detected location on the panoramic image window. The display unit also displays an identifier identifying the frame. Furthermore, the display unit displays, in the time zone window, the identifier identifying the frame and a field in which a band is displayed to indicate a period of time during which to monitor an occurrence of motion in the area indicated by the frame. If the detection unit detects that a location on the time zone window is specified, the display unit displays a time zone corresponding to the detected location and also displays an area corresponding to the detected location as a motion detection area.

Further features and advantages of the present invention will become apparent from the following description of the preferred embodiments with reference to the attached drawings.

### BRIEF DESCRIPTION OF THE DRAWINGS

FIG. 1 is a block diagram illustrating a monitoring system including an information processing apparatus according to a first embodiment of the present invention;

FIG. 2 is a schematic diagram illustrating a panoramic image for use in performing setting associated with motion detection;

FIGS. 3A-3B illustrate a manner in which detection time zones are set;

FIG. 4 is a diagram illustrating a manner in which setting performed via a time zone setting window is confirmed via a panorama window;

FIG. 5 is a block diagram illustrating a monitoring device and a terminal device according to the first embodiment of the present invention;

FIGS. 6A-6B are a flow chart illustrating a process flow including displaying a panoramic image with FIG. 6A illustrating process flow performed by the terminal device and FIG. 6B illustrating process flow performed by the monitoring device;

FIG. 7 is a flow chart illustrating a process of updating a motion detection area;

FIG. 8 is a flow chart illustrating a process of displaying a motion detection area on a panoramic image opened from the time zone setting window;

FIG. 9 is a diagram illustrating a user interface of an information processing apparatus according to a second embodiment of the present invention;

FIG. 10 is a diagram illustrating a manner in which a motion detection area is displayed on a panoramic image in connection with information displayed in a history window; and

FIGS. 11A-11C are diagrams illustrating examples of motion detection areas in image capturing areas.

### DESCRIPTION OF THE PREFERRED EMBODIMENTS

An embodiment of the present invention is described below.

System Configuration

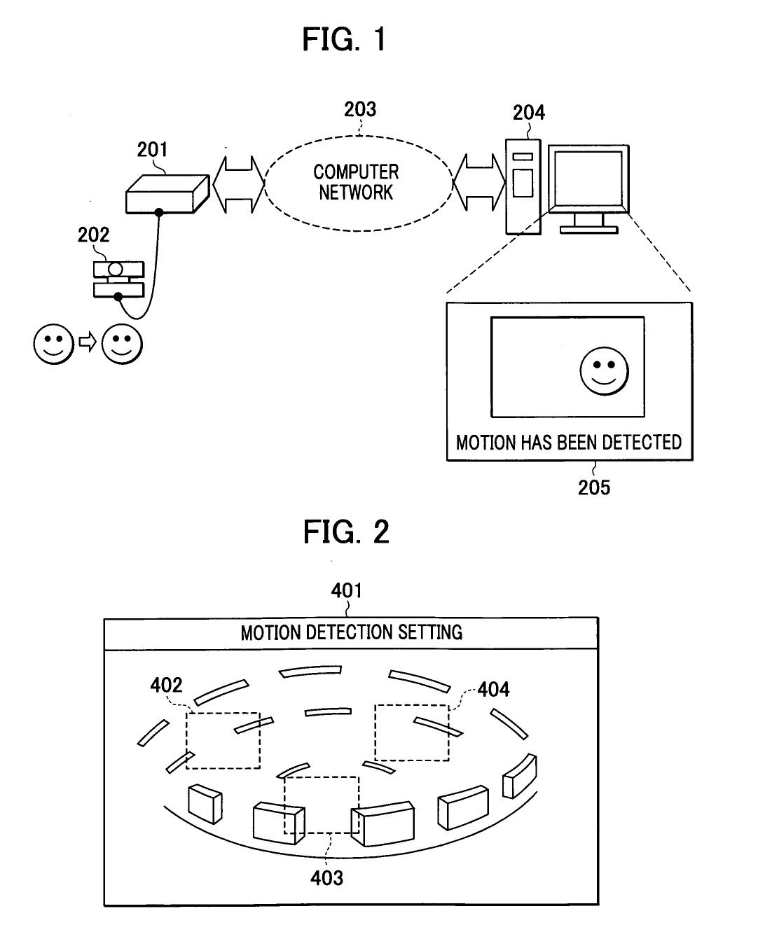

FIG. 1 is a block diagram illustrating a monitoring system according to a first embodiment of the present invention. This monitoring system is for monitoring a remote place via a network.

As shown in FIG. 1, a monitoring device 201 in the form of a box is installed at a place to be monitored.

A video camera 202 is connected with the monitoring device 201. In the present embodiment, the video camera 202 has panning, tilting, and zooming capabilities. An image taken by the video camera 202 is transmitted to an information processing apparatus serving as a terminal device 204 via a network 203 such as the Internet. In addition to the image, text and/or voice may also be provided. For example, the text and/or voice may state “motion detected.” A display 205 is connected with the terminal device 204, and the image taken by the video camera 202 is displayed on the display 205.

Note that the present invention may also be applied to a system in which no image is displayed but only information indicating detected motion of a subject is supplied in the form of text and/or voice information.

In the present embodiment, of various capabilities of the monitoring device 201, detection of motion of a subject is achieved using the video camera 202. If a greater amount of motion than a predetermined threshold is detected in an image taken by the video camera 202, the monitoring device 201 determines that motion has occurred and notifies the terminal device 204 of the occurrence of motion. In response, the terminal device 204 displays information on the display 205 to indicate that motion has been detected.

Information for detecting motion includes a motion detection position, a detection time zone, and a detection sensitivity. The “motion detection position” specifies a camera position (an image pickup direction of a camera) determined by panning, tilting, and zooming of the camera 202 used to detect motion. In the present embodiment, an image capturing area of the camera 202 is set and detailed setting is performed to define a motion detection area in the image capturing area. In short, each of the motion detecting areas corresponds to each of the image pickup directions. If the orientation of the camera 202 is changed in the middle of the motion detection process, a change in image caused by the change in camera orientation can be incorrectly regarded as a change caused by actual motion of the image. In the present embodiment, to prevent such incorrect detection, the orientation of the camera 202 is fixed and zooming operation is disabled (zooming ratio is fixed to a specified value) during the motion detection process.

The “detection time zone” specifies a time zone during which an occurrence of motion is monitored. In the present embodiment, by panning, tilting, and/or zooming the video camera 202, it is possible to switch the motion detection position depending on the time zone. For example, an entrance door may be monitored during daytime, and an emergency exit may be monitored during nighttime.

The “detection sensitivity” specifies motion detection sensitivity with which to detect motion in a camera position specified as the motion detection position (hereinafter, a “motion detection area” will also be used to denote an image area to be monitored in a specified camera position). More specifically, when a change is detected for a greater percentage of pixels of an image in a particular period (2 seconds, for example) than a value specified as the detection sensitivity, it is determined that motion has occurred. For example, when the detection sensitivity is set to 100, when a change is detected for all pixels, it is determined that motion has occurred. On the other hand, in the case in which the detection sensitivity is set to 50, when a change is detected for 50% or a greater percentage of pixels, it is determined that motion has occurred.

User Interface for Performing Setting Associated with Motion Detection

Referring to FIGS. 2, 3, and 4, a user interface for performing setting associated with motion detection in accordance with the present embodiment is described below. FIG. 2 is a schematic diagram illustrating a panoramic image used in setting of motion detection.

In the example shown in FIG. 2, a panoramic image taken over a full range by the camera 202 is displayed in a panorama window 401 for use in setting of motion detection. That is, the panorama window 401 shows the range that can be covered in taking an image by panning, tilting, and/or zooming a single camera. In the present embodiment, setting is performed using a panoramic image as follows.

Rectangles 402-404 indicating motion detection areas are displayed in the panorama window 401. The center of each of the rectangles 402-404 corresponds to the orientation (determined by panning and tilting) of the camera 202, and the size of each rectangle corresponds to the field of view determined by the zoom ratio.

More specifically, if a point on the panorama window 401 is clicked with a pointing device such as a mouse, a rectangle centered at the clicked point is drawn as one of rectangles 402-404. At this stage, the rectangle has a default size (for example, an intermediate size within an allowed range). The zoom ratio can be set by adjusting the size of each of rectangular frames 402-404, for example, by dragging the frame of a desired rectangle using the pointing device or the like. In addition to the rectangular frames 402-404, fields corresponding to the rectangular frames are displayed in a time zone setting window, and bands are displayed in the fields to indicate time zones during which to monitor occurrence of motion, as will be described in further detail later.

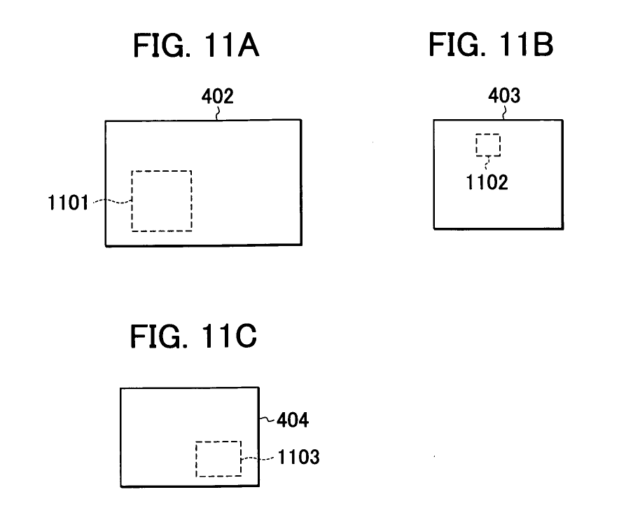

After rectangular frames (specifying the panning, tilting, and zooming values of the camera 202) are drawn at particular locations, if the inside of an arbitrary rectangle is clicked, the clicked rectangle is enlarged as shown in FIGS. 11A-1C. In an example shown in FIG. 11A, the rectangle 402 shown in FIG. 2 is displayed in an enlarged fashion in response to clicking. In the enlarged rectangle 402, a user can define a motion detection area to be monitored in terms of motion of image. In the example shown in FIG. 11A, a motion detection area is specified by an area 1101.

In an example shown in FIG. 11B, as in the example shown in FIG. 11A, the rectangle 403 shown in FIG. 2 is displayed in an enlarged fashion in response to clicking, and a motion detection area is specified by an area 1102. In an example shown in FIG. 11C, the rectangle 404 shown in FIG. 2 is displayed in an enlarged fashion in response to clicking, and a motion detection area is specified by an area 1103. It is desirable that usually moving images not be included in any of the motion detection areas because if the selected area includes such a usually moving image, it is extremely difficult to determine whether unusual motion is detected or whether motion of a usually moving image is detected. That is, a motion detection area should be adequately set for each orientation of the camera so that unusual motion can be correctly detected.

In addition, this system can set a motion detection area on the panorama window 401 without depending on the set of rectangular frames 402-404. In this case, it is an area in which image data to be extracted for motion detecting process that is an area in which frames 402-404 and the motion detection area.

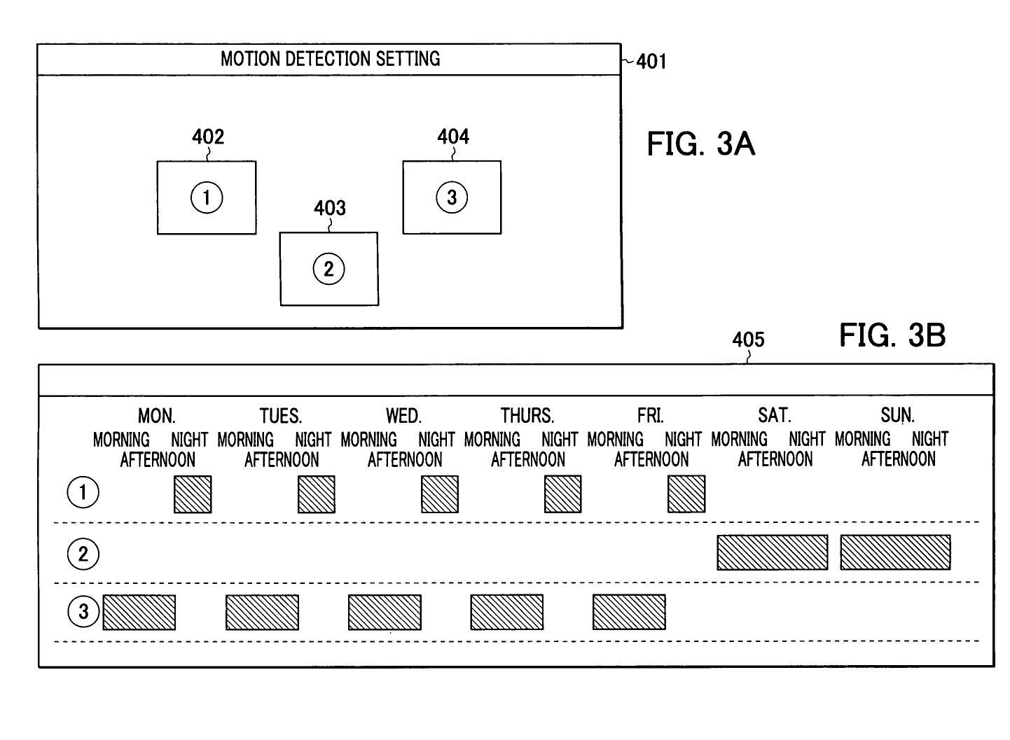

FIGS. 3A and 3B are diagrams illustrating a manner in which detection time zones are set. FIG. 3A illustrates the panorama window 401 in which image capturing areas each including a motion detection area are displayed. More specifically, rectangular frames 402-404 indicating image capturing areas are displayed on a panoramic image produced by combining images taken by the video camera 202. Although not shown in FIG. 3A, motion detection areas 1101-1103 are also displayed on the panoramic image in addition to the rectangular frames 402-404. The panoramic image indicates a maximum allowable range within which the video camera 202 can be panned, tilted, and/or zoomed in taking an image. This allows a user to easily recognize where to set an image capturing area and where to set a motion detection area. FIG. 3B illustrates a time zone setting window 405 serving as a user interface for setting detection time zones. In FIG. 3B, bands (1), (2) and (3) corresponding to respective rectangular frames (shown in FIG. 3A) are displayed to specify detection time zones during which to monitor motion in the motion detection areas in those rectangular frames.

When detection time zones are set, the time zone setting window 405 such as that shown in FIG. 3B and the panorama window 401 such as that shown in FIG. 3A are displayed separately. Alternatively, the panorama window 401 shown in FIG. 3A and the time zone setting window 405 shown in FIG. 3B may be combined into a single window including a panorama subwindow and a time zone setting subwindow. For example, a panorama subwindow may be displayed in an upper portion of a display and a time zone setting subwindow may be displayed in a lower portion of the same display.

In the present embodiment, as shown in FIG. 3B, each day in the week is divided into three time zones, that is, morning, afternoon, and nighttime, each of which can be assigned, as a detection time zone, to one of motion detection areas. Note that the rectangular frames 402, 403, and 404 are assigned numbers (1) (2), and (3), respectively.

Any time zone can be changed by clicking it with a pointing device. For example, to assign Saturday nighttime as an additional detection time zone to the rectangular frame (1) including the motion detection area 1101, a band corresponding to Saturday nighttime in row (1) in the time zone setting window 405 is clicked. In response, Saturday nighttime is added to the detection schedule of the motion detection area (1), and Saturday nighttime is removed from the detection schedule of the rectangular frame (2) including the motion detection area 1102. However, in a case in which zooming is set such that, for example, the rectangular frame (1) includes the rectangular frame (2), Saturday nighttime is not removed from the detection schedule of the motion detection area (2). In a case in which the rectangular frames (1) and (2) are closely adjacent to each other, it is possible to monitor motion in both areas by setting the zoom ratio of the video camera 202 to a wide angle. In this case, areas in both rectangular frames (1) and (2) are set as motion detection areas to be monitored during the specified time zone. That is, in a case in which a plurality of rectangular frames are assigned to the same time zone, one or all of those rectangular frames are employed as motion detection areas depending on relative positions of those rectangular frames.

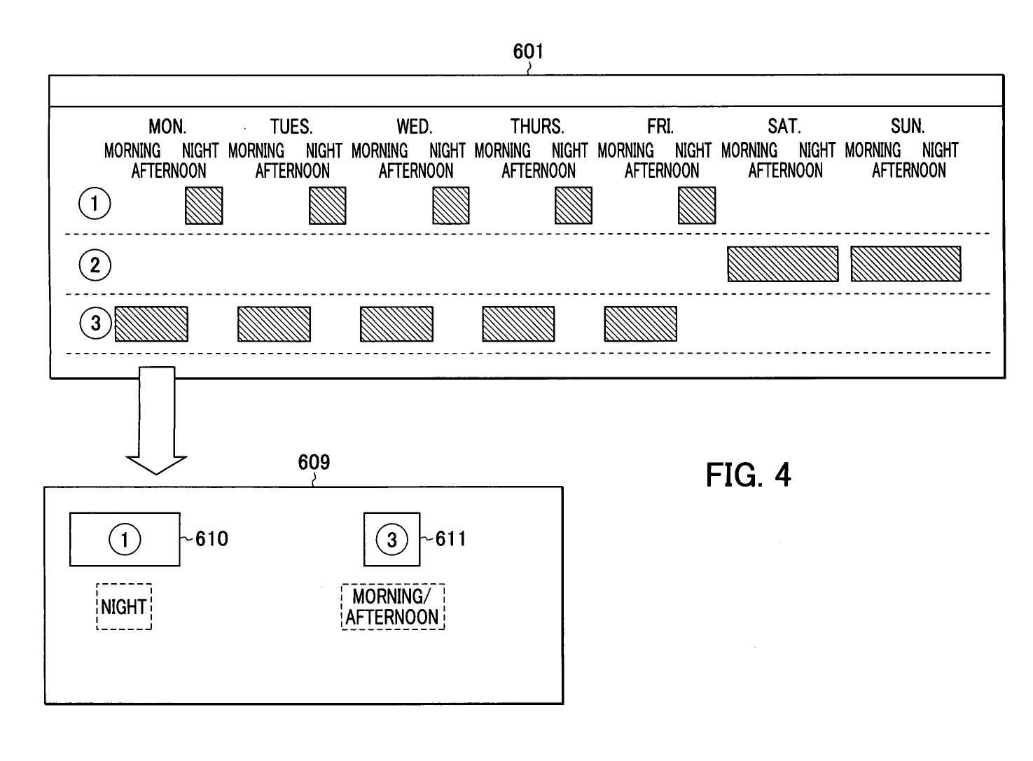

FIG. 4 shows a manner in which detection time zones set via the time zone setting window 601 are confirmed via the panorama window 609.

If a particular day of the week in a time zone setting window 601 is selected using the pointing device or the like, motion areas and time zones (morning, afternoon, or nighttime) assigned to the motion areas on the selected day of the week are displayed in the panorama window 609. In the example shown in FIG. 4, Monday is selected, and motion areas and time zones assigned to the motion areas on Monday are displayed in the panorama window 609. In the panorama window 609, rectangular frames 610 and 611 including motion detection areas are displayed, and time zones (morning, afternoon, or nighttime) assigned to the rectangular frames 610 and 611 are displayed below the respective rectangular frames 610 and 611, thereby allowing a user to make confirmation on the setting for each day of the week.

Constructions of Monitoring Device and Terminal Device

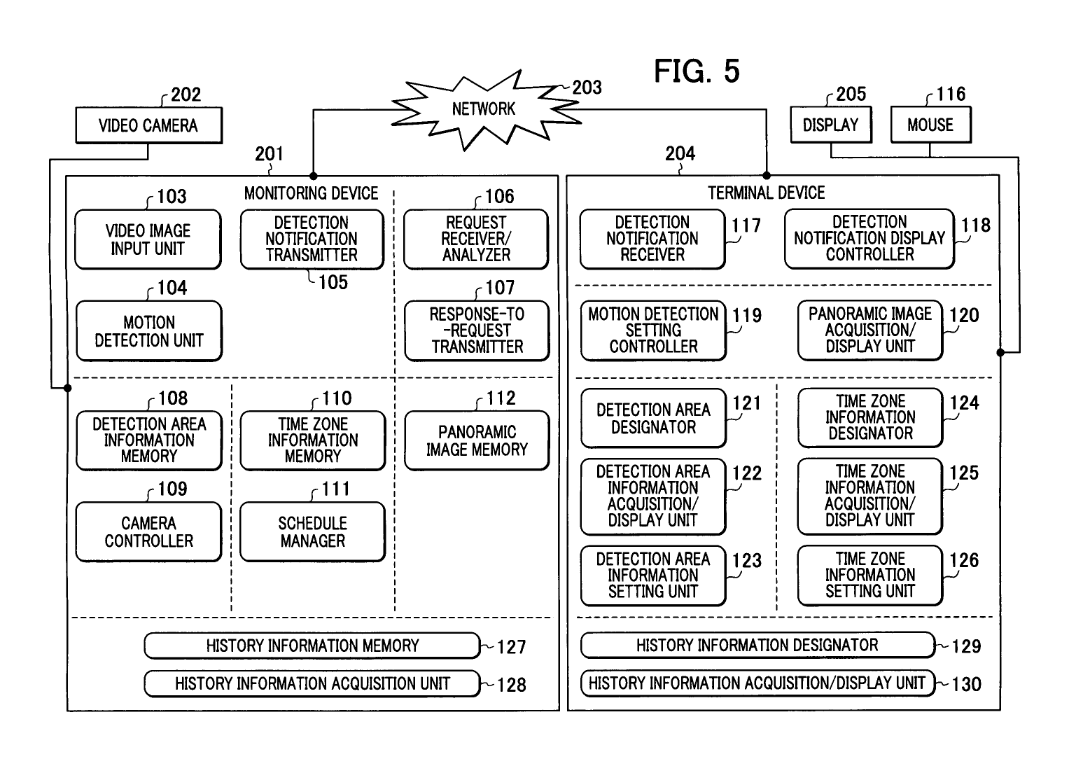

Referring now to FIG. 5, constructions for realizing the present embodiment are described. FIG. 5 is a block diagram illustrating constructions of the monitoring device 201 and the terminal device 204 according to the present embodiment. Each block in the monitoring device 201 and the terminal device 204 is controlled by a CPU (not shown) in accordance with program code stored in a storage medium.

As shown in FIG. 5, the monitoring device 201 is connected with the video camera 202. The monitoring device 201 is also connected with the terminal device 204 via a network 203. A display 205 serving as an output device and a mouse 116 serving as an input device are connected with the terminal device 204.

The monitoring device 201 includes various modules such as a video image input unit 103, a motion detection unit 104, a detection notification transmitter 105, a request receiver/analyzer 106, a response-to-request transmitter 107, a motion detection area information memory 108, a camera controller 109, a time zone information memory 110, a schedule manager 111, and a panoramic image memory 112.

The video image input unit 103 is a module that periodically captures an image taken by the video camera 202 and transmits the captured image to the motion detection unit 104. The motion detection unit 104 determines whether a change has occurred in the image. If the motion detection unit 104 detects a change in an image greater than a predetermined threshold, the motion detection unit 104 informs the terminal device 204 via the detection notification transmitter 105 that the change has been detected in the image. Communication units (detection notification transmitter 105, request receiver/analyzer 106, response-to-request transmitter 107, and detection notification receiver 117) are realized by a known communication mechanism such as TCP/IP.

If the request receiver/analyzer 106 receives a request from the terminal device 204, the request receiver/analyzer 106 determines the type of the request and transfers the request to a proper module depending on the type of the request. The request issued by the terminal device 204 includes an ID number identifying the type of the request. The response-to-request transmitter 107 is a module that transmits a response to the request to the terminal device 204.

The motion detection area information memory 108 is a module that stores information associated with motion detection areas and information associated with setting of image capturing areas including motion detection areas. The motion detection area information memory 108 is realized by a mechanism of storing data, such as a storage disk or a database.

In the present embodiment, information associated with an image capturing area and a motion detection area is given by a data series including: area number=<number>, pan=<pan value>, tilt=<tilt value>, zoom=<zoom value>, upper left <x, y> indicating the address of the upper left pixel of the motion detection area, and lower right <x, y> indicating the address of the lower right pixel of the motion detection area. Examples of data series are shown below:

area number=1, pan=100, tilt=20, zoom=30, upper left <10, 10>, lower right <40, 80>;

area number=2, pan=100, tilt=30, zoom=10, upper left <50, 10>, lower right <100, 120>;

area number=3, pan=2000, tilt=30, zoom=100, upper left <150, 50>, lower right <220, 150>.

The specific parameters assigned as pan, tilt, and zoom values depend on the specifications of the control mechanism of the video camera 202. For example, angles with respect to an initial position are employed as parameters for pan and tilt, and a zoom ratio is employed as a parameter for zoom.

The camera controller 109 is a module that controls the camera 202 such that the camera 202 is in a specified position in accordance with information stored in the motion detection area information memory 108. The time zone information memory 110 is a module that stores information associated with setting of time zones. As with the motion detection area information memory 108, the time zone information memory 110 is realized by a mechanism of storing data, such as a storage disk or a database.

In the present embodiment, time zone information is given by data in the form of area number=<number>, day-of-week 1 (time zone), day-of-week 2 (time zone), . . . .

For example, in the case in which setting is performed as shown in FIG. 3B, time zone information is given by:

area number=1, Monday (nighttime), Tuesday (nighttime), Wednesday (nighttime), Thursday (nighttime), Friday (nighttime);

area number=2, Saturday (morning, afternoon, nighttime), Sunday (morning, afternoon, nighttime);

area number=3, Monday (morning, afternoon), Tuesday (morning, afternoon), Wednesday (morning, afternoon), Thursday (morning, afternoon), Friday (morning, afternoon).

The schedule manager 111 controls the operation of the camera 202 according to time zone information in cooperation with the camera controller 109. The panoramic image memory 112 is a module that stores a panoramic image. In the present embodiment, a panoramic image such as that shown in FIG. 2 is given by some proper method.

History information memory 127 stores motion detection history information instead of time zone information. The history information acquisition unit 128 monitors the motion detection unit 104. If the history information acquisition unit 128 receives a motion detection notification from the motion detection unit 104, the history information acquisition unit 128 transfers a copy of the received motion detection notification to the history information memory 127 to store it therein.

The terminal device 204 includes modules such as a detection notification receiver 117, a detection notification display controller 118, a motion detection setting controller 119, a panoramic image acquisition/display unit 120, a motion detection area designator 121, a motion detection area information acquisition/display unit 122, a motion detection area information setting unit 123, a time zone information designator 124, a time zone information acquisition/display unit 125, and a time zone information setting unit 126.

The detection notification receiver 117 is a module that receives a motion detection notification transmitted by the detection notification transmitter 105. The received motion detection notification is displayed on the display 205 by the detection notification display controller 118. The motion detection setting controller 119 is a module that deals with operation associated with an input device, such as a mouse 116 for changing settings shown on the display 205. For example, when a menu is selected on a panoramic image or a button is clicked, the motion detection setting controller 119 interprets the meaning of such an operation. In accordance with the interpretation, the motion detection setting controller 119 performs a proper process using a proper module.

The panoramic image acquisition/display unit 120 has capabilities to acquire a panoramic image from the monitoring device 201 and display it on the display 205 as shown in FIG. 2.

The motion detection area designator 121 is a module for performing processing associated with setting of motion detection areas and image capturing areas. For example, processing associated with displaying of a rectangular frame on a panoramic image using a mouse 116 is performed by the motion detection area designator 121.

The motion detection area information acquisition/display unit 122 acquires motion detection area information from the monitoring device 201 and displays a rectangular frame on a panoramic image in accordance with the acquired motion detection area information. The motion detection area information setting unit 123 is a module that transmits, to the monitoring device 201, information associated with motion detection areas and image capturing areas added or changed by the motion detection area designator 121.

The time zone information designator 124 is a module that performs processing associated with setting of time zones. More specifically, processing associated with setting of a time zone via the time zone setting window is performed by the time zone information designator 124.

The time zone information acquisition/display unit 125 acquires time zone information from the monitoring device 201 and displays it on the time zone setting window. The time zone information acquisition/display unit 125 also has a capability of displaying a motion detection area assigned to a particular time zone on the panoramic image.

The time zone information setting unit 126 is a module that transmits, to the monitoring device 201, time zone information added or changed by the time zone information designator 124 to perform setting associated with time zones.

The history information designator 129 detects an entry of history information specified by a user. The history information acquisition/display unit 130 displays a window in accordance with motion detection history information acquired from the monitoring device 201.

Processing Flow

In the present embodiment, an image capturing area including a motion detection area is displayed on the panoramic image, and a window for performing setting associated with the motion detection areas/image capturing areas and a window for performing setting associated with time zones can be opened from either window, thereby providing a highly friendly user interface via which a user can easily perform desired setting. The flow of processing according to the present embodiment is described below. Of the modules shown in FIG. 5, modules 103-107, 117, and 118 are similar to those used in conventional monitoring systems, and therefore details of modules 103-107, 117, and 118 are not described herein.

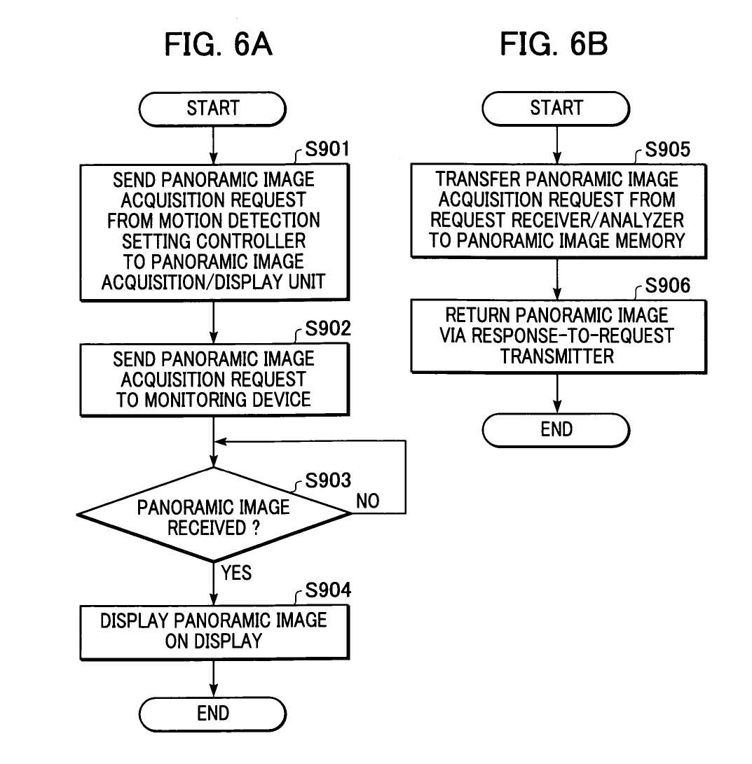

If a user starts a motion detection setting operation, for example, by selecting a particular menu, a panoramic image 401 such as that shown in FIG. 2 is displayed. The process including displaying of the panoramic image 401 is described below referring to flow charts shown in FIGS. 6A and 6B, wherein FIG. 6A shows a flow of processing performed by the terminal device 204, and FIG. 6B shows a flow of processing performed by the monitoring device 201.

If the motion detection setting controller 119 determines that the user has started a motion detection setting operation, the motion detection setting controller 119 sends a panoramic image acquisition command to the panoramic image acquisition/display unit 120 (step S901). Herein, the term “command” is used to describe a command processed locally in the terminal device 204 or in the monitoring device 201, while the term “request” is used to describe a request transmitted between the terminal device 204 and the monitoring device 201.

The panoramic image acquisition/display unit 120 transmits a panoramic image acquisition request to the monitoring device 201 (step S902). In the present embodiment, it is assumed that the monitoring device includes only one video camera 202, and thus the panoramic image acquisition request does not need to include particular addition information. However, in a case in which the monitoring device is connected with a plurality of video cameras, if identification information such as an ID number identifying a camera is added to the panoramic image acquisition request, the present embodiment can be applied to the monitoring device. Thereafter, the terminal device 204 waits for a response from the monitoring device 201 (step S903).

In the monitoring device 201, if the panoramic image acquisition request is received by the request receiver/analyzer 106, the request is transferred to the panoramic image memory 112 (step S905). The panoramic image memory 112 transmits a stored panoramic image to the terminal device 204 via the response-to-request transmitter 107 (step S906).

The transmitted panoramic image is received by the panoramic image acquisition/display unit 120 in the terminal device 204 (step S903). If the panoramic image acquisition/display unit 120 receives the panoramic image, the panoramic image acquisition/display unit 120 displays the panoramic image on the display 205 (step S904).

If the panoramic image is displayed, it becomes possible to perform the motion detection area setting operation described earlier with reference to FIG. 2. If a user performs a predetermined operation to perform motion detection area setting, the motion detection setting controller 119 detects it and transmits a motion detection area setting command to the motion detection area information acquisition/display unit 122.

In a similar manner to the panoramic image acquisition process, motion detection area information is acquired.

That is, the motion detection area information acquisition/display unit 122 transmits the motion detection area setting request to the monitoring device 201, and waits for a response from the monitoring device 201.

In the monitoring device 201, if the motion detection area setting request is received by the request receiver/analyzer 106, the request is transferred to the motion detection area information memory 108. The motion detection area information memory 108 transmits stored motion detection area information to the terminal device 204 via the response-to-request transmitter 107.

The transmitted motion detection area information is received by the motion detection area information acquisition/display unit 122 in the terminal device 204. If the motion detection area information acquisition/display unit 122 receives the motion detection area information, the motion detection area information acquisition/display unit 122 displays rectangular frames indicating a motion detection area and an image capturing area on the panoramic image displayed on the display 205.

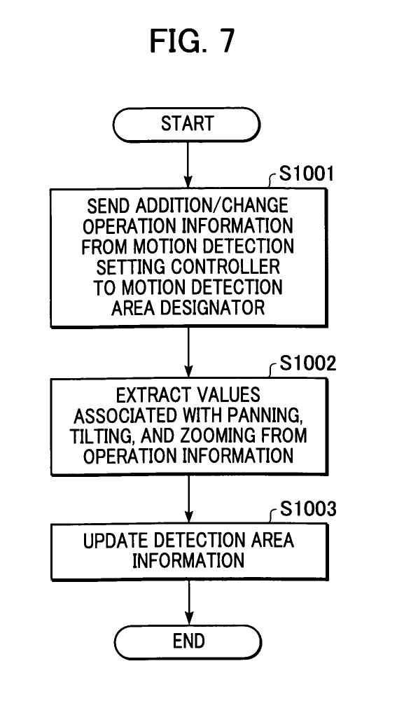

Referring to FIG. 7, a flow of a motion detection area updating process is described below.

If a user adds a new motion detection area or changes an existing motion detection area, for example, by clicking a point on the panoramic image, the operation performed by the user is detected by the motion detection setting controller 119, and the motion detection setting controller 119 sends information associated with the operation performed by the user to the motion detection area designator 121 (step S1001). If the motion detection area designator 121 detects that, for example, a rectangular frame 402 is requested by the user to be added or changed, the motion detection area designator 121 extracts necessary information such as a pan value and a tilt value (step S1002). The motion detection area designator 121 updates the information associated with the image capturing area in accordance with the extracted information. In a case in which a motion detection area has already been set, if the location and/or the size of a rectangular frame is changed, the absolute motion detection area is changed. However, the absolute motion detection area should not be changed even if the location of a rectangular frame is changed. Therefore, to maintain the absolute motion detection area unchanged, the address of the motion detection area is updated when the location of a rectangular frame is changed (step S1003).

When the user sets motion detection area information, a setting command is transferred to the motion detection area information setting unit 123 via the motion detection setting controller 119. To make setting associated with the motion detection area information, the motion detection area setting unit 123 transmits a motion detection area setting request together with new motion detection area information to the monitoring device 201. For example, when a rectangular frame including a motion detection area is newly added, the time zone information acquisition/display unit 125 displays an additional field corresponding to the motion detection area in the time zone setting window 601.

The motion detection area setting request is received by the request receiver/analyzer 106 and transferred to the motion detection area information memory 108. The motion detection area information memory 108 extracts motion detection area information from the request and stores the extracted motion detection area information.

Setting associated with time zones is performed in a similar manner to the setting associated with motion detection area, as described below.

If a user performs a predetermined operation to make setting associated with a time zone, the motion detection setting controller 119 detects it and transmits a time zone information setting command to the time zone information acquisition/display unit 125.

In response, the time zone information acquisition/display unit 125 acquires time zone information in a similar manner to acquisition of motion detection area information. The time zone information acquisition/display unit 125 transmits the time zone information setting request to the monitoring device 201, and waits for a response from the monitoring device 201. In the monitoring device 201, if the time zone information acquisition request is received by the request receiver/analyzer 106, the request is transferred to the time zone information memory 110. The time zone information memory 110 transmits stored time zone information to the terminal device 204 via the response-to-request transmitter 107.

The time zone information is received by the time zone information acquisition/display unit 125 in the terminal device 204. The time zone information acquisition/display unit 125 displays the received time zone information on the display 205. In this case, the time zone information is not displayed on the panoramic image but in another window (time zone information setting window) as shown in FIG. 3B.

Processing associated with addition/change of time zone information is performed in a similar manner to processing associated with addition/change of motion detection area information, as described below.

If a user performs an operation to add a new time zone or to change an existing time zone, for example, by clicking a point in the time zone information setting window, the operation performed by the user is detected by the motion detection setting controller 119, and the motion detection setting controller 119 sends information associated with the operation performed by the user to the time zone information designator 124. If the time zone information designator 124 receives the information associated with the operation of adding or changing the time zone, the time zone information designator 124 extracts information associated with the time zone from the received information and updates the current time zone information.

Furthermore, in response to the operation associated with setting of time zone information, a setting command is transmitted to the time zone information setting unit 126 via the motion detection setting controller 119. The time zone information setting unit 126 transmits a time zone information setting request together with new time zone information to the monitoring device 201.

The time zone information setting request is received by the request receiver/analyzer 106 and transferred to the time zone information memory 110. The time zone information memory 110 extracts time zone information from the request and stores the extracted time zone information.

The processing flow associated with displaying of a motion detection area corresponding to a time zone shown in FIG. 4 is described below.

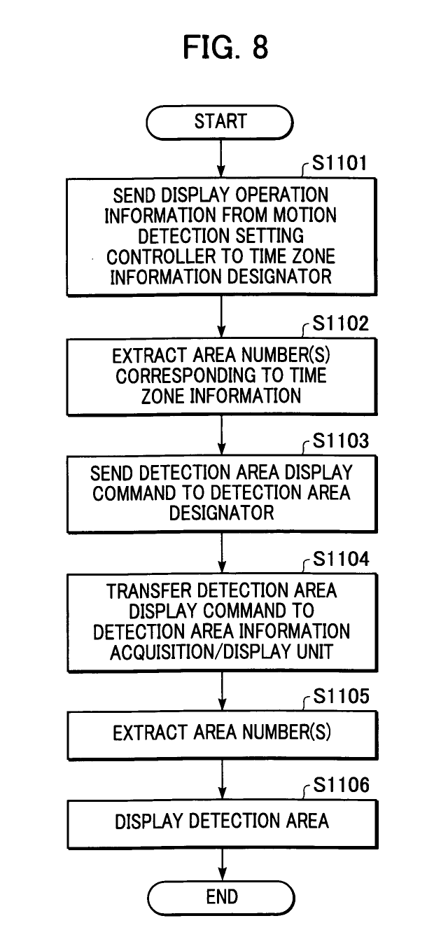

FIG. 8 is a flow chart illustrating a process of displaying motion detection areas in a panoramic image window opened from the time zone setting window.

In the present embodiment, displaying of a motion detection area is started in response to a particular operation performed on the time zone information setting window. Information indicating the operation performed by a user is transmitted from the motion detection setting controller 119 to the time zone information designator 124 (step S1101). The time zone information designator 124 extracts an area number (or area numbers) corresponding to the given time zone information (step S1102), and the time zone information designator 124 transmits a motion detection area display command together with the extracted area number(s) to the motion detection area designator 121 (step S1103).

If the motion detection area designator 121 receives the motion detection area display command, the motion detection area designator 121 transfers it to the motion detection area information acquisition/display unit 122 (step S1104). The motion detection area information acquisition/display unit 122 extracts the area number(s) from the command to display the image capturing area including the motion detection area(s) (step S1105), and the motion detection area information acquisition/display unit 122 displays the motion detection area(s) in a normal fashion or a highlighted fashion (step S1106).

Via the process described above, the user interface shown in FIG. 4 is realized. In the present embodiment, as described above, a motion detection area and an image capturing area are displayed on a panoramic image, and an arbitrary window for performing detailed setting can be opened from the panoramic image window, thereby providing a highly friendly user interface via which a user can easily perform desired setting.

Displaying of Motion Detection History Information

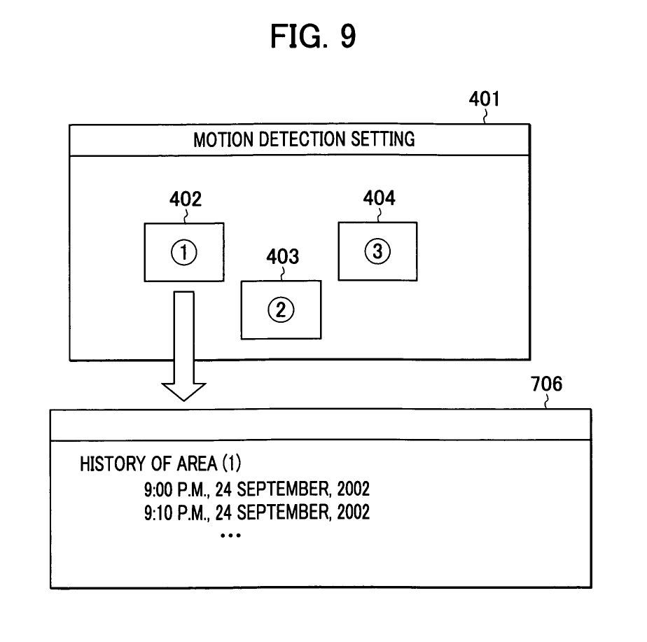

FIG. 9 is a diagram illustrating a user interface of an information processing apparatus according to another embodiment of the present invention. This user interface according to the present embodiment provides information about a history of motion detection.

In the example shown in FIG. 9, three rectangular frames 402, 403, and 404 each including a motion detection area are displayed in a panorama window 401. In the present embodiment, if one of those rectangular frames is selected, the history information designator 129 detects the selection operation, and the history information acquisition/display unit 130 acquires and stores history information associated the selection operation. If a particular entry of the history information is specified, the history information acquisition/display unit 130 displays the specified entry of the history information in the history window 706.

In the example shown in FIG. 9, a motion detection history of a motion detection area 402 is displayed in the history window 706. The motion detection history information displayed in the history window 706 includes times at which motion was detected. As with the time zone setting, the panorama window can be opened from the history window.

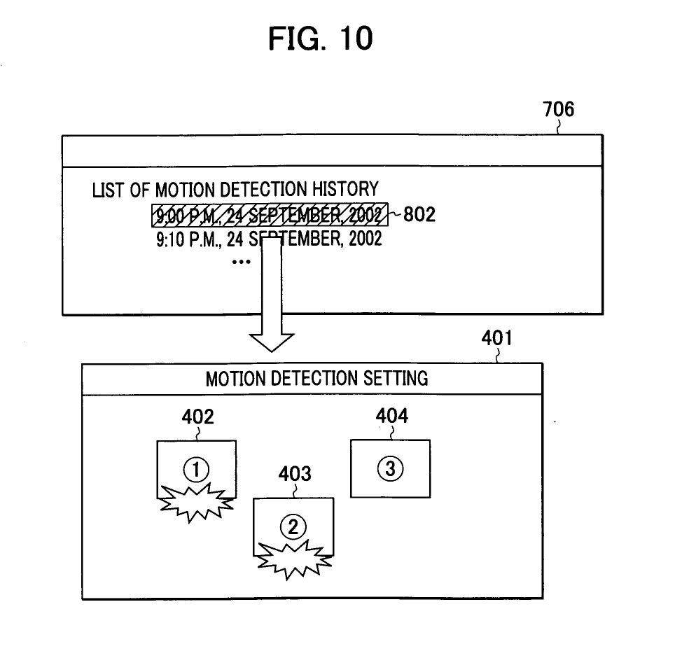

FIG. 10 illustrates a manner in which the panorama window is opened from the history window.

As shown in FIG. 10, if an entry 802 of the history information is selected on a history window 706, the history information designator 129 detects the selection operation. In response, the history information acquisition/display unit 130 displays information in the panorama window 401 so as to indicate in which motion detection area(s) the motion was detected at the time described in the selected entry of the history information. In the example shown in FIG. 10, the rectangular frames 402 and 403 in which motion was detected are displayed in a manner different from the manner in which the rectangular frame 404 is displayed so that the user can easily recognize that motion was detected in the motion detection areas (1) and (2) in the rectangular frames 402 and 403, respectively.

Note that the present invention is not limited to the details of the embodiments described above. The invention may be applied not only to a system including a plurality of devices but also to an apparatus including a single device. A storage medium may be supplied, on which a software program or programs implementing the functions of any of the embodiments described above is stored, to a system or an apparatus whereby a computer (CPU or MPU) in the system or apparatus reads and executes the program code stored on the storage medium.

In this case, it should be understood that the program code read from the storage medium implements the functions of invention and thus the storage medium storing the program code falls within the scope of present invention. Specific examples of storage media which can be preferably employed in the present invention to supply the program code include a floppy disk (registered trademark), a hard disk, an optical disk, a magneto-optical disk, a CD-ROM, a CD-R, a magnetic tape, a nonvolatile memory card, and a ROM. Furthermore, the scope of the present invention includes not only such an apparatus in which the functions of any embodiment described above is implemented simply by reading and executing program code on a computer but also an apparatus in which part or all of process is performed by an operating system (OS) running on the computer in accordance with the program code.

Furthermore, the scope of the present invention also includes an apparatus or a system in which program code is transferred once from a storage medium into a memory provided in a function extension board inserted in a computer or provided in a function extension unit connected to the computer, and then a part or all of a process is performed by a CPU or the like in the function extension board or the function extension unit in accordance with the program code thereby implementing the functions of any embodiment described above.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A terminal device for monitoring an image output from an imaging device, comprising:
a display unit for displaying, on a screen, a panoramic image window and a time zone window in which a band is displayed to indicate a time zone during which to monitor an occurrence of motion in the image output by the imaging device;
a detection unit for detecting a specified location on the screen; and
a setting unit for performing setting associated with a motion detection process in accordance with a display status of the time zone window,
wherein if the detection unit detects that a location on the panoramic image window is specified, the display unit displays a frame indicating an area to be monitored for motion in an area including the detected location on the panoramic image window, displays an identifier identifying the frame, and displays, in the time zone window, the identifier identifying the frame and a field in which a band is displayed to indicate a period of time during which to monitor an occurrence of motion in the area indicated by the frame, and
wherein if the detection unit detects that a location on the time zone window is specified, the display unit displays a time zone corresponding to the detected location and displays an area corresponding to the detected location as a motion detection area.

2. The terminal device according to claim 1, wherein the setting unit determines whether a plurality of areas are assigned as motion detection areas to the same time zone depending on relative locations of the plurality of areas.

3. The terminal device according to claim 1, wherein the panoramic image window and the time zone window are subwindows in a single window.

4. The terminal device according to claim 1, wherein when the detection unit detects that the specified location on the screen is a frame on the panoramic image window, the display unit displays a list window including a list of times at which image motion was detected in the past in an area corresponding to the specified frame.

5. The terminal device according to claim 1, wherein the display unit displays a list window including a list of times at which image motion was detected in the past, and, if the detection unit detects that the specified location on the screen is a location on the list window, the display unit displays, on the panoramic image window, an area in which motion was detected at a time corresponding to the specified location.

6. A method of monitoring an image output from an imaging device, comprising the steps of:
(a) displaying, on a screen, a panoramic image window and a time zone window in which a band is displayed to indicate a time zone during which to monitor an occurrence of motion in the image taken by the imaging device;
(b) performing setting associated with a motion detection process in accordance with a display status of the time zone window;
(c) if a location on the panoramic image window is specified:
(i) displaying a frame indicating an area to be monitored for motion together with an identifier identifying the frame in an area including the specified location on the panoramic image window; and
(ii) displaying in the time zone window the identifier identifying the frame and a field in which a band is displayed to indicate a period of time during which to monitor an occurrence of motion in the area indicated by the frame; and
(d) if a location on the time zone window is specified:
(i) displaying a time zone corresponding to the specified location; and
(ii) displaying an area corresponding to the specified location as a motion detection area.

7. The method according to claim 6, wherein step (b) comprises making a determination of whether to assign a plurality of areas as motion detection areas to the same time zone depending on relative locations of the plurality of areas.

8. The method according to claim 6, wherein the panoramic image window and the time zone window are subwindows in a single window.

9. The method according to claim 6, wherein step (a) further comprises displaying a list window including a list of times at which image motion was detected in the past in an area corresponding to the frame in the area including the specified location on the panoramic image window.

10. The method according to claim 6, wherein step (a) further comprises displaying a list window including a list of times at which image motion was detected in the past, and, further comprising:
(e) if a location on the list window is specified, displaying an area in which motion was detected at a time corresponding to the specified location on the panoramic image window.

11. A storage medium including, stored therein, program code for implementing a method of monitoring an image output from an imaging device, the method comprising the steps of:
(a) displaying, on a screen, a panoramic image window and a time zone window in which a band is displayed to indicate a time zone during which to monitor an occurrence of motion in the image taken by the imaging device;
(b) performing setting associated with a motion detection process in accordance with a display status of the time zone window;
(c) if a location on the panoramic image window is specified:
(i) displaying a frame indicating an area to be monitored in terms of motion together with an identifier identifying the frame in an area including the specified location on the panoramic image window; and
(ii) displaying in the time zone window the identifier identifying the frame and a field in which a band is displayed to indicate a period of time during which to monitor an occurrence of motion in the area indicated by the frame; and
(d) if a location on the time zone window is specified:
(i) displaying a time zone corresponding to the specified location; and
(ii) displaying an area corresponding to the specified location as a motion detection area.

12. The storage medium according to claim 11, wherein in step (b), a determination of whether a plurality of areas are assigned as motion detection areas to the same time zone is made depending on relative locations of the plurality of areas.

13. The storage medium according to claim 11, wherein the panoramic image window and the time zone window are subwindows in a single window.

14. The storage medium according to claim 11, wherein step (a) further comprises displaying a list window including a list of times at which image motion was detected in the past in an area corresponding to the frame in the area including the specified location on the panoramic image window.

15. The storage medium according to claim 11 wherein step (a) further comprises displaying a list window including a list of times at which image motion was detected in the past, and, further comprising:
(e) if a location on the list window is specified, displaying an area in which motion was detected at a time corresponding to the specified location on the panoramic image window.

16. A terminal device for monitoring an image output from an imaging device, comprising:
a setting unit for changing a set area of image data to be extracted for motion detecting process corresponding to changing set of an image sensing area of the imaging device and.
a storing unit for storing information on the set area of image data to be extracted for the motion detecting process and information on the set area of an image sensing area of the imaging device.

17. The terminal device according to claim 16, further comprising;
a display unit for displaying a panoramic image which indicates an image sensing range of the imaging device, and
wherein said setting unit sets the area of image data to be extracted for the motion detecting process and the image sensing range of an imaging device on the panoramic image.

18. A method for monitoring an image output from an imaging device, comprising the steps of:
changing an area of image data to be extracted for motion detecting process corresponding to changing set of the image sensing area of the imaging device; and
detecting motion of an object on the basis of the changed area of image data to be extracted for motion detecting process.

19. The method according to claim 18, further comprising the step of:
setting the area of image data to be extracted for the motion detecting process and an image sensing range of the imaging device on a panoramic image which indicates the image sensing range of the imaging device.

20. A storage medium which stores program code to execute a method for monitoring an image output from an imaging device, the method comprising the steps of:
changing an area of image data to be extracted for motion detecting process corresponding to changing set of the image sensing area of the imaging device; and
detecting motion of an object on the basis of the changed area of image data to be extracted for motion detecting process.

21. The storage medium according to claim 20, wherein the method further comprises the step of setting the area of image data to be extracted for the motion detecting process and an image sensing range of the imaging device on a panoramic image which indicates the image sensing range of the imaging device.
